(19) United States
(12) Patent Application Publication
(10) Pub. No.: US 2025/0303724 A1
(43) Pub. Date: Oct. 2, 2025

(54) INK JET RECORDING APPARATUS

(71) Applicant: SEIKO EPSON CORPORATION, Tokyo (JP)

(72) Inventors: Tadashi WATANABE, Matsumoto-shi (JP); Tadahiro MIZUTANI, Shiojiri-shi (JP); Yuta KOIKE, Matsumoto-shi (JP)

(73) Assignee: SEIKO EPSON CORPORATION, Tokyo (JP)

(21) Appl. No.: 19/091,950

(22) Filed: Mar. 27, 2025

(30) Foreign Application Priority Data
Mar. 28, 2024 (JP) 2024-052733

(51) Int. Cl. B41J 2/175

(52) U.S. Cl. CPC B41J 2/17506; B41J 2/17513

(57) ABSTRACT

In an ink jet recording apparatus, a pouring portion includes a needle portion that communicates with an ink accommodation chamber, a peripheral wall that is disposed to surround an outer periphery of the needle portion, an inner bottom portion that receives ink inside the peripheral wall, one or more communication portions that are open at the inner bottom portion and that communicate with the ink accommodation chamber, and a plurality of groove portions of which at least a portion is formed at the inner bottom portion, and the plurality of groove portions are configured to communicate with at least one of the one or more communication portions such that two or more groove portions communicate with each communication portion.

The present application is based on, and claims priority from JP Application Serial Number 2024-052733, filed Mar. 28, 2024, the disclosure of which is hereby incorporated by reference herein in its entirety.

### BACKGROUND

### 1. Technical Field

The present disclosure relates to an ink jet recording apparatus.

### 2. Related Art

In the related art, an ink jet recording apparatus that can perform printing on a printing medium, such as printing paper, with ink by ejecting the ink toward the printing medium from a recording head is known. Examples of such an ink jet recording apparatus include an ink replenishment type ink jet recording apparatus in which ink is used with an ink tank replenished with ink by means of an ink bottle. Disclosed in JP-A-2020-168790 is an ink jet recording apparatus including a pouring portion in which ink leaking at the time of replenishment with ink is received at an ink reception portion and the ink is guided to an ink accommodation portion via a guide portion and a communication portion.

When the amount of ink leakage at the time of the replenishment with ink is large in the ink jet recording apparatus in JP-A-2020-168790, ink may stagnate at the ink reception portion and the ink stagnating thereat may adhere to the ink bottle for the replenishment with ink or trickle out of the pouring portion. Accordingly, a user or each portion of the ink jet recording apparatus may be contaminated with the ink.

### SUMMARY

1. According to a first aspect of the present disclosure, there is provided an ink jet recording apparatus including a recording head that records an image by ejecting ink and an ink tank including an ink accommodation chamber that accommodates the ink to be supplied to the recording head and a pouring portion that communicates with the ink accommodation chamber and through which the ink is poured from an ink bottle. In the ink jet recording apparatus, the pouring portion includes a needle portion that communicates with the ink accommodation chamber, a peripheral wall that is disposed to surround an outer periphery of the needle portion, an inner bottom portion that receives the ink inside the peripheral wall, one or more communication portions that are open at the inner bottom portion and that communicate with the ink accommodation chamber, and a plurality of groove portions of which at least a portion is formed at the inner bottom portion, and the plurality of groove portions are configured to communicate with at least one of the one or more communication portions such that two or more groove portions communicate with each communication portion.

2. According to a second aspect of the present disclosure, there is provided an ink jet recording apparatus including a recording head that records an image by ejecting ink and an ink tank including an ink accommodation chamber that accommodates the ink to be supplied to the recording head and a pouring portion that communicates with the ink accommodation chamber and through which the ink is poured from an ink bottle. In the ink jet recording apparatus, the pouring portion includes a needle portion that communicates with the ink accommodation chamber, a peripheral wall that is disposed to surround an outer periphery of the needle portion, an inner bottom portion that receives the ink inside the peripheral wall, and one or more communication portions that are open at the inner bottom portion and that communicate with the ink accommodation chamber, and the peripheral wall includes a third groove portion that is formed at an inner peripheral surface of the peripheral wall and that guides the ink toward the inner bottom portion.

3. According to a third aspect of the present disclosure, there is provided an ink jet recording apparatus including a recording head that records an image by ejecting ink and an ink tank including an ink accommodation chamber that accommodates the ink to be supplied to the recording head and a pouring portion that communicates with the ink accommodation chamber and through which the ink is poured from an ink bottle. In the ink jet recording apparatus, the pouring portion includes a needle portion that communicates with the ink accommodation chamber, a peripheral wall that is disposed to surround an outer periphery of the needle portion, an inner bottom portion that receives the ink inside the peripheral wall, and one or more communication portions that are open at the inner bottom portion and that communicate with the ink accommodation chamber, the needle portion includes a fourth groove portion that is formed at an outer peripheral surface of the needle portion and that guides the ink toward the inner bottom portion, and an upper end of the fourth groove portion is positioned below a sealed portion disposed at an ink outlet portion of the ink bottle in a state where the ink bottle is coupled to the needle portion.

### BRIEF DESCRIPTION OF THE DRAWINGS

FIG. 1 is a perspective view of a printer according to a first embodiment.

FIG. 2 is a perspective view showing a state where ink tanks are replenished with ink by means of an ink bottle.

FIG. 3 is a perspective view of an ink tank according to the first embodiment.

FIG. 4 is a sectional view showing a replenishment state where the ink tank is replenished with ink from the ink bottle.

FIG. 5 is a top view showing a configuration of a pouring portion of the first embodiment.

FIG. 6 is a perspective view showing the configuration of the pouring portion of the first embodiment.

FIG. 7 is a top view showing a configuration of the pouring portion of a second embodiment.

FIG. 8 is a perspective view showing a configuration of a pouring portion of a third embodiment.

FIG. 9 is a perspective view showing a configuration of a pouring portion of a fourth embodiment.

FIG. 10 is an enlarged view showing the vicinity of a communication portion of a pouring portion in a fifth embodiment.

FIG. 11 is a perspective view showing a configuration of a pouring portion of a sixth embodiment.

FIG. 12 is a perspective view showing a configuration of a pouring portion of a seventh embodiment.

### DESCRIPTION OF EMBODIMENTS

### A. First Embodiment

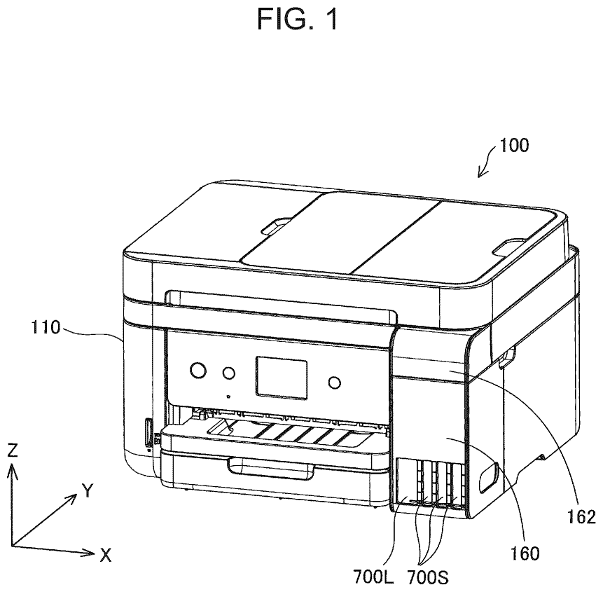

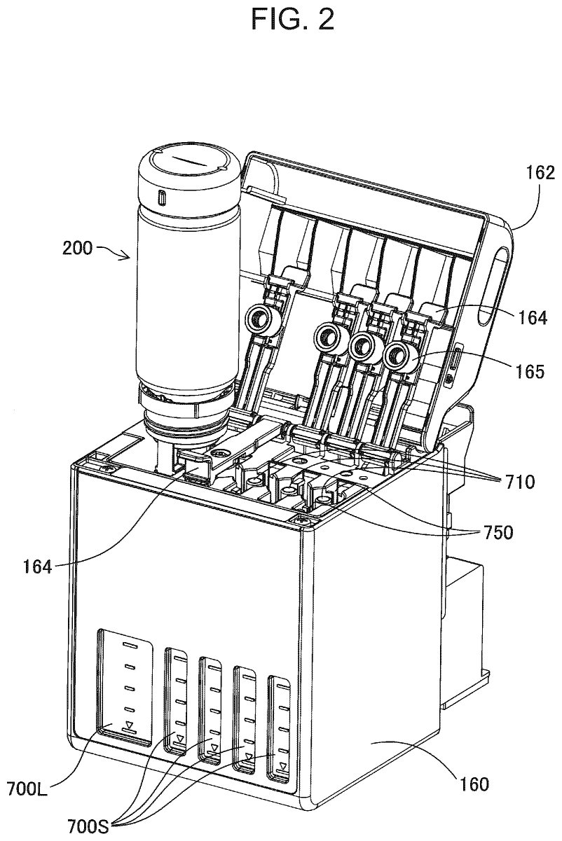

FIG. 1 is a perspective view of a printer 100 according to a first embodiment. The printer 100 is an ink jet printer that performs printing by ejecting ink onto a printing medium with a recording head. The printer 100 corresponds to an “ink jet recording apparatus” in the present disclosure. In FIG. 2, an X-axis, a Y-axis, and a Z-axis orthogonal to each other are shown. The X-axis corresponds to a width direction of the printer 100, the Y-axis corresponds to a depth direction of the printer 100, and the Z-axis corresponds to a height direction of the printer 100. The printer 100 is installed on a horizontal installation surface defined by an X-axis direction and a Y-axis direction. Note that the “X-axis direction” means a concept in which a +X direction and a −X direction are combined. Similarly, the “Y-axis direction” means a concept in which a +Y direction and a −Y direction are combined, and the “Z-axis direction” means a concept in which a +Z direction and a −Z direction are combined.

The printer 100 includes a housing 110. A carriage (not shown) movable in the X-axis direction, which is a main scanning direction, is provided inside the housing 110. A recording head that ejects ink onto a printing medium is installed in the carriage. An ink tank accommodation unit 160 that accommodates a plurality of ink tanks 700S and 700L is provided at one end of a front surface of the housing 110. The ink tank accommodation unit 160 includes a lid 162 that can be opened and closed at a top portion of the ink tank accommodation unit 160. Note that the ink tanks 700S are small-capacity tanks, and the ink tank 700L is a large-capacity tank. Meanwhile, in the following description, both the ink tanks will be simply referred to as “ink tanks 700” without distinction. Each ink tank 700 is coupled to the recording head of the carriage by means of a tube (not shown). That is, the ink tanks 700 are stationary ink tanks that are not mounted on the carriage of the printer 100. In addition, each ink tank 700 is an ink replenishment type ink tank that is replenished with ink from an ink bottle when the amount of remaining ink is low. Note that although the ink tanks 700 are stationary ink tanks in the present embodiment, the ink tanks 700 may be installed on the carriage of the printer 100.

FIG. 2 is a perspective view showing a state where the ink tanks 700 are replenished with ink by means of an ink bottle 200. A front surface of each ink tank 700 is formed of a transparent member, and the amount of remaining ink in each ink tank 700 can be seen from the outside. When the amount of remaining ink is low, as shown in FIG. 2, replenishment with ink can be performed through needle portions 711 of the ink tanks 700 after opening the lid 162.

For each ink tank 700, a pouring portion 710 for replenishment of the ink tank 700 with ink is provided at an upper surface of the ink tank 700. The ink tank accommodation unit 160 includes sealing cap members 164 that include sealing caps 165 provided to seal the pouring portions 710. In a state where the ink tanks 700 are not replenished with ink, the pouring portions 710 are sealed by the sealing caps 165 of the sealing cap members 164. When the ink tanks 700 are to be replenished with ink, replenishment with ink is performed by separating the sealing cap members 164 from the pouring portions 710 and inserting a distal end portion of the ink bottle 200 to the pouring portions 710. Specific configurations of the pouring portions 710 will be described later. Note that in FIG. 2, peripheral walls 712, which will be described later, are not shown.

In the present specification, a term “replenishment with ink” means an operation of supplying ink to the ink tanks 700 to increase the amount of remaining ink. Meanwhile, the ink tanks 700 do not need to be filled up with ink through the “replenishment with ink”. In addition, the “replenishment with ink” also means an operation of filling the empty ink tanks 700 with ink when the printer 100 is used for the first time.

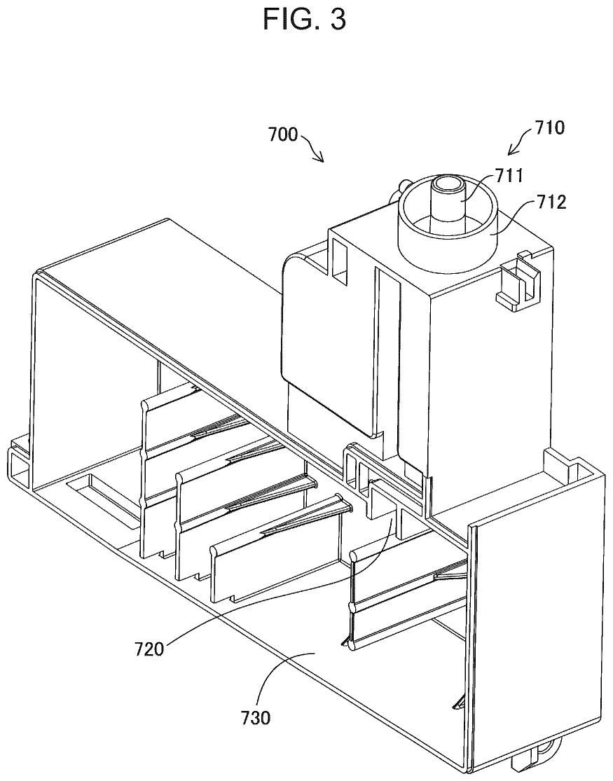

FIG. 3 is a perspective view of the ink tank 700 according to the first embodiment. The pouring portion 710 of the ink tank 700 includes the needle portion 711 that protrudes upward from the ink tank 700. A distal end portion of the needle portion 711 is open and communicates with an in-tank flow path 720 that protrudes in an ink accommodation chamber 730 on a lower side. A lower end of the in-tank flow path 720 extends to a position below the ceiling wall of the ink accommodation chamber 730. This is because, air-liquid exchange is stopped and replenishment with ink is also stopped due to the stoppage of the air-liquid exchange when a liquid level in the ink accommodation chamber 730 reaches the lower end of the in-tank flow path 720 at the time of replenishment of the ink tank 700 with ink from the ink bottle 200, which makes the replenishment with ink easy.

In the present embodiment, the pouring portion 710 further includes the peripheral wall 712 that surrounds the needle portion 711. Therefore, ink leaking at the time of replenishment with ink from the ink bottle 200 can be restrained from scattering around the needle portion 711. In the present embodiment, the peripheral wall 712 is formed in a cylindrical shape surrounding the needle portion 711. Note that the shape of the peripheral wall 712 is not limited to the cylindrical shape, and may be, for example, a quadrangular tubular shape or an elliptical tubular shape. In addition, in FIG. 3, the height of the peripheral wall 712 is shown to be lower than the height of the needle portion 711. However, the height of the peripheral wall 712 may be the same as the height of the needle portion 711 or may be higher than the height of the needle portion 711.

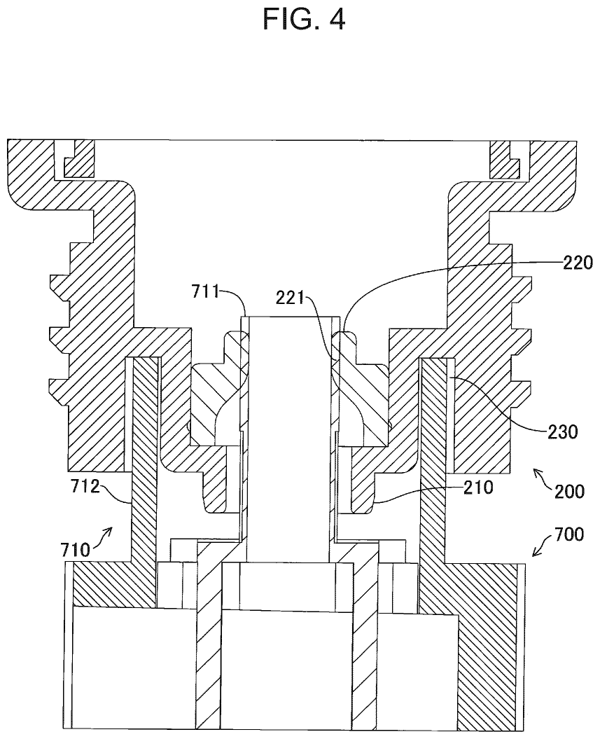

FIG. 4 is a sectional view showing a replenishment state where the ink tank 700 is replenished with ink from the ink bottle 200. In FIG. 4, only a portion of each of the ink bottle 200 and the ink tank 700 is shown. As shown in FIG. 4, in the replenishment state where the ink bottle 200 is coupled to the needle portion 711, the needle portion 711 is inserted into an ink outlet portion 210 of the ink bottle 200. The ink bottle 200 includes a seal member 220 provided in the ink outlet portion 210. The seal member 220 is brought into close contact with an outer peripheral surface of the needle portion 711 in the replenishment state to form a sealed portion 221, so that ink leakage from the outer peripheral surface of the needle portion 711 at the time of replenishment with ink can be suppressed and contamination of the ink tank 700 can be suppressed.

The ink bottle 200 of the present embodiment has a reception portion 230 formed in an annular shape around the ink outlet portion 210. In the replenishment state, the reception portion 230 receives the peripheral wall 712 and a bottom portion of the reception portion 230 and a distal end portion of the peripheral wall 712 are in a state of abutting each other. Since the ink bottle 200 of the present embodiment includes the reception portion 230, the peripheral wall 712 can be received in the replenishment state, and contact between the peripheral wall 712 and the distal end portion of the ink bottle 200 in the replenishment state, which hinders insertion of the needle portion 711 into the ink outlet portion 210, can be suppressed.

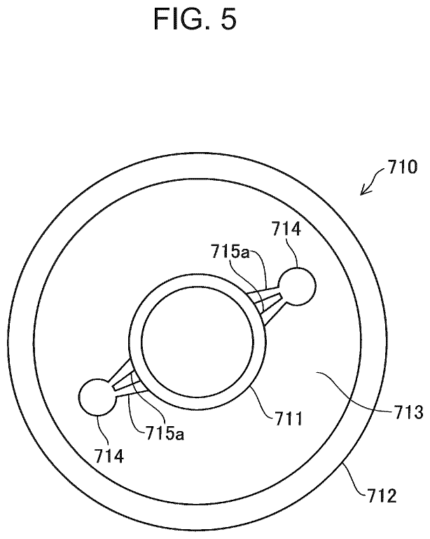

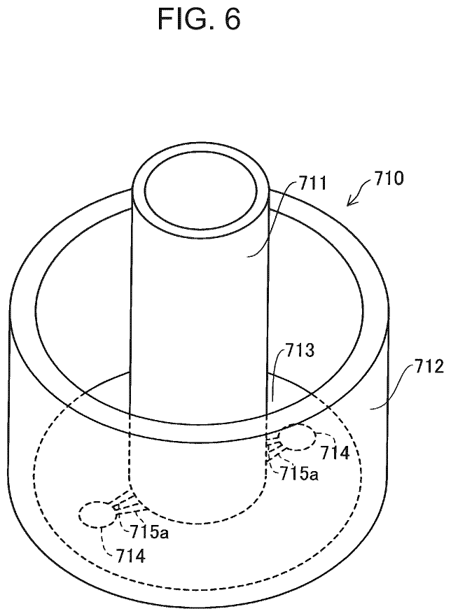

FIG. 5 is a top view showing a configuration of the pouring portion 710 of the first embodiment. FIG. 6 is a perspective view showing the configuration of the pouring portion 710 of the first embodiment. As shown in FIGS. 5 and 6, the pouring portion 710 includes an inner bottom portion 713, two communication portions 714, and four first groove portions 715a in addition to the needle portion 711 and the peripheral wall 712 described above. The inner bottom portion 713 forms a bottom portion of an inner space surrounded by the peripheral wall 712. The inner bottom portion 713 receives ink leaking from the ink bottle 200 at the time of replenishment with ink from the ink bottle 200. In the present embodiment, the inner bottom portion 713 is a flat surface that is not inclined.

The communication portions 714 are open in the inner bottom portion 713 and communicate with the ink accommodation chamber 730. In other words, the communication portions 714 are configured as through-holes penetrating the inner bottom portion 713 in a thickness direction. Therefore, ink stored in the inner bottom portion 713 can be guided to the ink accommodation chamber 730 and ink leaking from the ink bottle 200 can be restrained from stagnating at the inner bottom portion 713. In the present embodiment, the communication portions 714 have cylindrical shapes, and are provided between the needle portion 711 and the peripheral wall 712 at positions that do not abut both of an inner peripheral surface of the peripheral wall 712 and the outer peripheral surface of the needle portion 711.

In addition, the pouring portion 710 includes the two communication portions 714 provided symmetrically with respect to the needle portion 711. Therefore, ink leaking from the ink bottle 200 can be further restrained from stagnating at the inner bottom portion 713 in comparison with an aspect in which only one communication portion is provided. Note that the pouring portion 710 may include three or more communication portions 714, and a plurality of the communication portions 714 may be disposed asymmetrically with respect to the needle portion 711. In addition, the pouring portion 710 may include only one communication portion 714.

Each of the first groove portions 715a is a groove formed at the inner bottom portion 713, and guides ink stagnating at the inner bottom portion 713 to the communication portion 714. In the present embodiment, bottom portions of the first groove portions 715a are flat surfaces that are not inclined. Each of the first groove portions 715a is provided to extend from the base of the needle portion 711 toward the communication portion 714, and guides ink trickling along the needle portion 711 from the base of the needle portion 711 to the communication portion 714. The “base of the needle portion 711” means a coupling portion between the needle portion 711 and the inner bottom portion 713. Therefore, ink trickling along the needle portion 711 can be restrained from stagnating at the inner bottom portion 713. Each first groove portion 715a corresponds to a “groove portion” in the present disclosure.

In addition, two first groove portions 715a are configured to communicate with one communication portion 714. Accordingly, ink can be prompted to be guided to the communication portions 714 in comparison with an aspect in which only one first groove portion 715a communicates with one communication portion 714. Note that three or more first groove portions 715a may communicate with one communication portion 714. In addition, a configuration in which a plurality of the first groove portions 715a communicate with only one of the two communication portions 714 and only one first groove portion 715a communicates with other of the two communication portions 714 or no first groove portion 715a communicates with the other of the two communication portions 714 may also be adopted.

In addition, each of the first groove portions 715a is formed to become thinner from the needle portion 711 toward the communication portion 714. Here, “to become thin” means to be reduced in area of a cross section orthogonal to a direction in which the groove portion extends and means not only to be reduced in width of the groove portion buy also to be reduced in depth of the groove portion. Accordingly, in each of the first groove portions 715a, the magnitude and the probability of capillary action can be increased toward the communication portion 714 and thus ink held at the first groove portion 715a is easily drawn into the communication portion 714. Therefore, ink can be prompted to be guided to the communication portion 714 and ink leaking from the ink bottle 200 can be further restrained from stagnating at the inner bottom portion 713. Note that only a portion of the plurality of first groove portions 715a may be formed to become thinner from the needle portion 711 toward the communication portion 714. In addition, all of the first groove portions 715a may be formed such that the widths of the first groove portions 715a are constant.

According to the printer 100 of the first embodiment described above, since two first groove portions 715a are configured to communicate with one communication portion 714, ink can be prompted to be guided to the communication portion 714 in comparison with an aspect in which only one first groove portion 715a communicates with one communication portion 714. Therefore, ink leaking from the ink bottle 200 can be further restrained from stagnating at the inner bottom portion 713 and contamination of a hand of a user or each portion of the printer 100 that is caused by ink when ink stagnating at the inner bottom portion 713 adheres to the ink bottle 200 or trickles out of the pouring portion 710 can be suppressed.

In addition, since each first groove portion 715a is configured to become thinner toward the communication portion 714, the magnitude and the probability of capillary action in the first groove portion 715a can be increased toward the communication portion 714 and thus ink held at the groove portion is easily drawn into the communication portion 714. Therefore, ink can be prompted to be guided to the communication portion 714 and ink leaking from the ink bottle 200 can be further restrained from stagnating at the inner bottom portion 713.

### B. Second Embodiment

The printer 100 of a second embodiment is different from the printer 100 of the first embodiment in that the ink tank 700 is provided with a pouring portion 710b instead of the pouring portion 710. Note that since other components of the printer 100 of the second embodiment are the same as those of the printer 100 of the first embodiment, the same components are given the same reference numerals and detailed description thereof will be omitted.

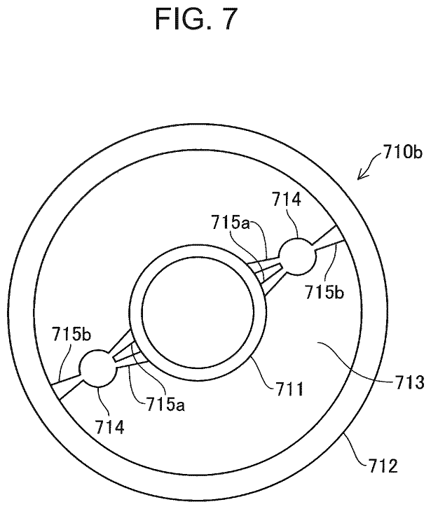

FIG. 7 is a top view showing a configuration of the pouring portion 710b of the second embodiment. As shown in FIG. 7, the pouring portion 710b of the second embodiment is different from the pouring portion 710 of the first embodiment in that the pouring portion 710b further includes two second groove portions 715b. Note that the number of the second groove portions 715b may be any number equal to or greater than one.

Each of the second groove portions 715b is a groove that is formed at the inner bottom portion 713 to extend from the inner peripheral surface of the peripheral wall 712 toward the communication portion 714, and guides, to the communication portion 714, ink trickling along the inner peripheral surface of the peripheral wall 712. Therefore, ink that leaks from the ink bottle 200, that adheres to the peripheral wall 712, and that trickles along the inner peripheral surface of the peripheral wall 712 can be restrained from stagnating at the inner bottom portion 713. The second groove portions 715b correspond to “groove portions” in the present disclosure.

In the present embodiment, the number of the first groove portions 715a communicating with one communication portion 714 may be one. In other words, the number of groove portions communicating with the communication portion 714 corresponds to the sum of the number of the first groove portions 715a communicating with the communication portion 714 and the number of the second groove portions 715b communicating with the communication portion 714, and is not limited as long as the sum is equal to or greater than two. That is, the number of groove portions communicating with the communication portion 714 is not limited as long as a plurality of groove portions including the first groove portion 715a and the second groove portion 715b communicate with the communication portion 714. According to such an aspect, ink can be further prompted to be guided to the communication portions 714 in comparison with an aspect in which only one groove portion communicates with one communication portion 714.

In addition, each of the second groove portions 715b is formed to become thinner from the peripheral wall 712 toward the communication portion 714. Accordingly, in each of the second groove portions 715b, the magnitude and the probability of capillary action can be increased toward the communication portion 714 and thus ink held at the second groove portion 715b is easily drawn into the communication portion 714. Therefore, ink can be prompted to be guided to the communication portion 714 and ink leaking from the ink bottle 200 can be further restrained from stagnating at the inner bottom portion 713. Note that only a portion of a plurality of the second groove portions 715b may be formed to become thinner from the peripheral wall 712 toward the communication portion 714. In addition, all of the second groove portions 715b may be formed such that the widths of the second groove portions 715b are constant.

According to the printer 100 of the second embodiment described above, the same effects as those of the above-described first embodiment are achieved. In addition, since the second groove portions 715b are further provided, ink that leaks from the ink bottle 200, that adheres to the peripheral wall 712, and that trickles along the inner peripheral surface of the peripheral wall 712 can be restrained from stagnating at the inner bottom portion 713. Therefore, ink leaking from the ink bottle 200 can be further restrained from stagnating at the inner bottom portion 713 and contamination of a hand of a user or each portion of the printer 100 that is caused by ink when ink adhering to the peripheral wall 712 adheres to the ink bottle 200 or trickles out of the pouring portion 710b can be further suppressed.

### C. Third Embodiment

The printer 100 of a third embodiment is different from the printer 100 of the second embodiment in that the ink tank 700 is provided with a pouring portion 710c instead of the pouring portion 710b. Note that since other components of the printer 100 of the third embodiment are the same as those of the printer 100 of the second embodiment, the same components are given the same reference numerals and detailed description thereof will be omitted.

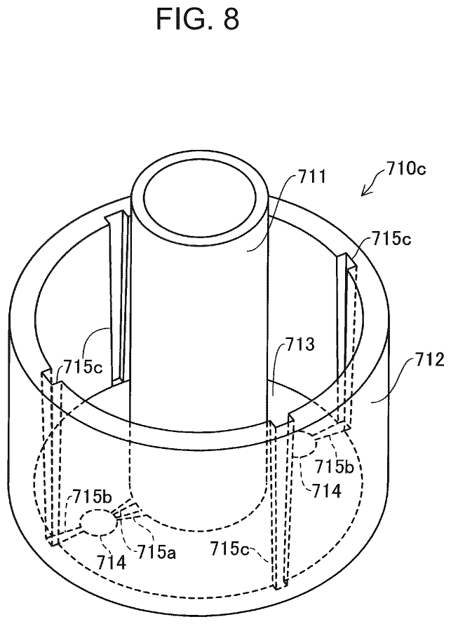

FIG. 8 is a perspective view showing the configuration of the pouring portion 710c of the third embodiment. As shown in FIG. 8, the pouring portion 710c of the third embodiment is different from the pouring portion 710b of the second embodiment in that the pouring portion 710c further includes four third groove portions 715c. Note that the number of the third groove portions 715c is not limited to four and may be any number equal to or greater than one.

Each of the third groove portions 715c is a groove that is formed at the inner peripheral surface of the peripheral wall 712 to extend toward the inner bottom portion 713 and guides, to the inner bottom portion 713, ink adhering to the peripheral wall 712. Therefore, ink that leaks from the ink bottle 200 can be restrained from adhering to and stagnating at the inner peripheral surface of the peripheral wall 712. Note that in the present embodiment, each of the third groove portions 715c is formed to be parallel to a height direction of the peripheral wall 712. The third groove portions 715c correspond to “groove portions” in the present disclosure.

In addition, each of the third groove portions 715c is formed to become thinner toward the inner bottom portion 713. Accordingly, in each of the third groove portions 715c, the magnitude and the probability of capillary action can be increased toward the inner bottom portion 713 and thus ink held at the third groove portion 715c is easily drawn into the inner bottom portion 713. Therefore, ink can be prompted to be guided to the inner bottom portion 713 and ink leaking from the ink bottle 200 can be further restrained from stagnating at the inner peripheral surface of the peripheral wall 712. Note that only a portion of a plurality of the third groove portions 715c may be formed to become thinner toward the inner bottom portion 713. In addition, all of the third groove portions 715c may be formed such that the widths of the third groove portions 715c are constant.

In addition, two of the four third groove portions 715c communicate with the second groove portions 715b, respectively. Therefore, ink held at the third groove portions 715c can be directly guided to the second groove portions 715b and ink adhering to the inner peripheral surface of the peripheral wall 712 can be more efficiently guided to the communication portions 714. Note that the number of the third groove portions 715c communicating with the second groove portions 715b is not limited to two and may be any number including zero.

According to the printer 100 of the third embodiment described above, the same effects as those of the above-described second embodiment are achieved. In addition, since the third groove portions 715c are further provided, ink leaking from the ink bottle 200 can be restrained from adhering to and stagnating at the inner peripheral surface of the peripheral wall 712 and contamination of a hand of a user or each portion of the printer 100 that is caused by ink when ink adhering to the peripheral wall 712 adheres to the ink bottle 200 or trickles out of the pouring portion 710c can be suppressed.

In addition, since two of the four third groove portions 715c communicate with the second groove portions 715b, ink held at the third groove portions 715c can be directly guided to the second groove portions 715b and ink adhering to the inner peripheral surface of the peripheral wall 712 can be more efficiently guided to the communication portions 714. Therefore, ink leaking from the ink bottle 200 can be restrained from adhering to and stagnating at the inner peripheral surface of the peripheral wall 712 and contamination of a hand of a user or each portion of the printer 100 that is caused by ink when ink adhering to the peripheral wall 712 adheres to the ink bottle 200 or trickles out of the pouring portion 710c can be suppressed.

### D. Fourth Embodiment

The printer 100 of a fourth embodiment is different from the printer 100 of the third embodiment in that the ink tank 700 is provided with a pouring portion 710d instead of the pouring portion 710c. Note that since other components of the printer 100 of the fourth embodiment are the same as those of the printer 100 of the third embodiment, the same components are given the same reference numerals and detailed description thereof will be omitted.

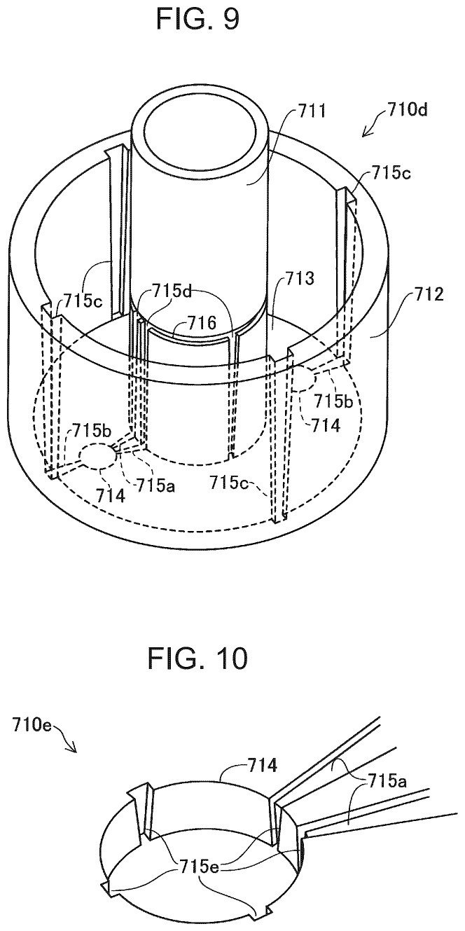

FIG. 9 is a perspective view showing the configuration of the pouring portion 710d of the fourth embodiment. As shown in FIG. 9, the pouring portion 710d of the fourth embodiment is different from the pouring portion 710c of the third embodiment in that the pouring portion 710d further includes fourth groove portions 715d and an annular groove 716. The pouring portion 710d includes six fourth groove portions 715d that are disposed asymmetrically with respect to the needle portion 711 although a portion of the fourth groove portions 715d are hidden in FIG. 9. Note that the number of the fourth groove portions 715d is not limited to six and may be any number equal to or greater than one.

Each of the fourth groove portions 715d is a groove that is formed at the outer peripheral surface of the needle portion 711 to extend toward the inner bottom portion 713 and guides, to the inner bottom portion 713, ink adhering to the outer peripheral surface of the needle portion 711. Therefore, ink that leaks from the ink bottle 200 can be restrained from adhering to and stagnating at the outer peripheral surface of the needle portion 711. Note that in the present embodiment, each of the fourth groove portions 715d is formed to be parallel to a height direction of the needle portion 711. The fourth groove portions 715d correspond to “groove portions” in the present disclosure.

In addition, each of the fourth groove portions 715d is formed such that an upper end portion of the fourth groove portion 715d is positioned below the above-described sealed portion 221 in the replenishment state. As a result, the upper end portions of the fourth groove portions 715d being positioned above the above-described sealed portion 221 in the replenishment state can be avoided and thus ink leakage that occurs when airtightness achieved by the sealed portion 221 is lost due to the fourth groove portions 715d can be suppressed.

In the present embodiment, the upper end portion of each of the fourth groove portions 715d communicates with the annular groove 716 formed at the outer peripheral surface of the needle portion 711. The annular groove 716 is formed to be parallel to a direction orthogonal to the height direction of the needle portion 711. Ink trickling along the outer peripheral surface of the needle portion 711 is guided to the fourth groove portions 715d after being temporarily held at the annular groove 716. Accordingly, the ink can be easily guided to the inner bottom portion 713 via the fourth groove portions 715d. Note that positions at which the annular groove 716 communicates with the fourth groove portions 715d are not limited to the upper end portions of the fourth groove portions 715d and the annular groove 716 may communicate with the fourth groove portions 715d at any positions in a height direction of the fourth groove portions 715d. Note that the pouring portion 710d may not include the annular groove 716.

In addition, each of the fourth groove portions 715d is formed to become thinner toward the inner bottom portion 713. Accordingly, in each of the fourth groove portions 715d, the magnitude and the probability of capillary action can be increased toward the inner bottom portion 713 and thus ink held at the fourth groove portion 715d is easily drawn into the inner bottom portion 713. Therefore, ink can be prompted to be guided to the inner bottom portion 713 and ink leaking from the ink bottle 200 can be further restrained from stagnating at the outer peripheral surface of the needle portion 711. Note that only a portion of a plurality of the fourth groove portions 715d may be formed to become thinner toward the inner bottom portion 713. In addition, all of the fourth groove portions 715d may be formed such that the widths of the fourth groove portions 715d are constant.

In addition, four of the six fourth groove portions 715d communicate with the first groove portions 715a, respectively. Therefore, ink held at the fourth groove portions 715d can be directly guided to the first groove portions 715a and ink adhering to the outer peripheral surface of the needle portion 711 can be more efficiently guided to the communication portions 714. Note that the number of the fourth groove portions 715d communicating with the first groove portions 715a is not limited to four and may be any number including zero.

According to the printer 100 of the fourth embodiment described above, the same effects as those of the above-described third embodiment are achieved. In addition, since the fourth groove portions 715d are further provided, ink leaking from the ink bottle 200 can be restrained from adhering to and stagnating at the outer peripheral surface of the needle portion 711 and contamination of a hand of a user or each portion of the printer 100 that is caused by ink when ink adhering to the needle portion 711 adheres to the ink bottle 200 or trickles out of the pouring portion 710d can be suppressed.

In addition, since an upper end of each of the fourth groove portions 715d is positioned below the sealed portion 221 disposed at the ink outlet portion 210 of the ink bottle 200 in the replenishment state, the upper end portions of the fourth groove portions 715d being positioned above the sealed portion 221 in a state where the ink bottle 200 is coupled to the needle portion 711 can be avoided and thus ink leakage that occurs when airtightness achieved by the sealed portion 221 is lost due to the fourth groove portions 715d can be suppressed.

### E. Fifth Embodiment

The printer 100 of a fifth embodiment is different from the printer 100 of the first embodiment in that the ink tank 700 is provided with a pouring portion 710e instead of the pouring portion 710. Note that since other components of the printer 100 of the fifth embodiment are the same as those of the printer 100 of the first embodiment, the same components are given the same reference numerals and detailed description thereof will be omitted.

FIG. 10 is an enlarged view showing the vicinity of the communication portion 714 of the pouring portion 710e in the fifth embodiment. As shown in FIG. 10, the pouring portion 710e of the fifth embodiment is different from the pouring portion 710 of the first embodiment in that the pouring portion 710e further includes five fifth groove portions 715e. Note that the number of the fifth groove portions 715e is not limited to five and may be any number equal to or greater than one.

The fifth groove portions 715e are grooves formed at the inner peripheral surface of the communication portion 714, and guide ink toward the ink accommodation chamber 730. Therefore, ink stagnating at the inner bottom portion 713 is guided to the ink accommodation chamber 730 through the fifth groove portions 715e and the ink stagnating at the inner bottom portion 713 can be prompted to be guided to the ink accommodation chamber 730. The fifth groove portions 715e correspond to “groove portions” in the present disclosure.

In addition, as shown in FIG. 10, the fifth groove portions 715e are formed to become thinner toward the ink accommodation chamber 730. Accordingly, in the fifth groove portions 715e, the magnitude and the probability of capillary action can be increased toward the ink accommodation chamber 730 and thus ink held at the fifth groove portions 715e is easily drawn into the ink accommodation chamber 730. Therefore, ink can be prompted to be guided to the ink accommodation chamber 730 and ink leaking from the ink bottle 200 can be further restrained from stagnating at the inner bottom portion 713. Note that only a portion of a plurality of the fifth groove portions 715e may be formed to become thinner toward the ink accommodation chamber 730. In addition, all of the fifth groove portions 715e may be formed such that the widths of the fifth groove portions 715e are constant.

In addition, two of the five fifth groove portions 715e communicate with the first groove portions 715a, respectively. Therefore, ink held at the first groove portions 715a can be directly guided to the fifth groove portions 715e and the ink held at the first groove portions 715a can be more efficiently guided to the ink accommodation chamber 730. Note that the number of the fifth groove portions 715e communicating with the first groove portions 715a is not limited to two and may be any number including zero.

Note that when the pouring portion 710e further includes the second groove portions 715b, at least a portion of the fifth groove portions 715e may communicate with the second groove portions 715b. According to such an aspect, ink held at the second groove portions 715b can be directly guided to the fifth groove portions 715e and the ink held at the second groove portions 715b can be more efficiently guided to the ink accommodation chamber 730.

According to the printer 100 of the fifth embodiment described above, the same effects as those of the above-described first embodiment are achieved. In addition, since the fifth groove portions 715e are further provided, ink stagnating at the inner bottom portion 713 is guided to the ink accommodation chamber 730 through the fifth groove portions 715e and the ink stagnating at the inner bottom portion 713 can be prompted to be guided to the ink accommodation chamber 730. Therefore, ink leaking from the ink bottle 200 can be further restrained from stagnating at the inner bottom portion 713 and contamination of a hand of a user or each portion of the printer 100 that is caused by ink when ink stagnating at the inner bottom portion 713 adheres to the ink bottle 200 or trickles out of the pouring portion 710e can be further suppressed.

### F. Sixth Embodiment

The printer 100 of a sixth embodiment is different from the printer 100 of the third embodiment in that the ink tank 700 is provided with a pouring portion 710f instead of the pouring portion 710c. Note that since other components of the printer 100 of the sixth embodiment are the same as those of the printer 100 of the third embodiment, the same components are given the same reference numerals and detailed description thereof will be omitted.

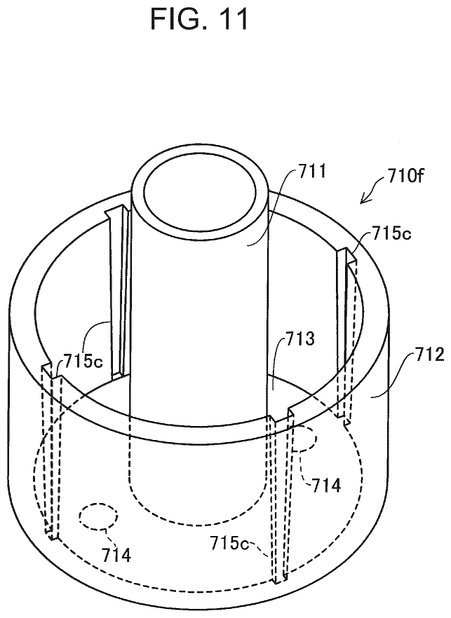

FIG. 11 is an explanatory view showing the configuration of the pouring portion 710f of the sixth embodiment. As shown in FIG. 11, the pouring portion 710f of the sixth embodiment is different from the pouring portion 710c of the third embodiment in that the pouring portion 710f does not include the first groove portions 715a and the second groove portions 715b.

According to the printer 100 of the above-described sixth embodiment, since the third groove portions 715c are provided, ink leaking from the ink bottle 200 can be restrained from adhering to and stagnating at the inner peripheral surface of the peripheral wall 712 and contamination of a hand of a user or each portion of the printer 100 that is caused by ink when ink adhering to the peripheral wall 712 adheres to the ink bottle 200 or trickles out of the pouring portion 710f can be suppressed.

### G. Seventh Embodiment

The printer 100 of a seventh embodiment is different from the printer 100 of the fourth embodiment in that the ink tank 700 is provided with a pouring portion 710g instead of the pouring portion 710d. Note that since other components of the printer 100 of the seventh embodiment are the same as those of the printer 100 of the fourth embodiment, the same components are given the same reference numerals and detailed description thereof will be omitted.

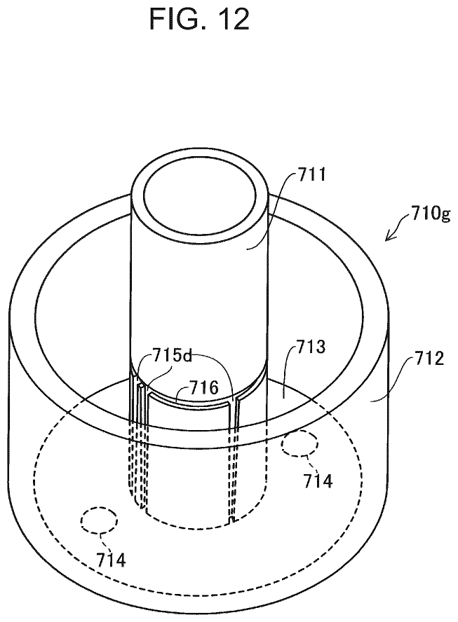

FIG. 12 is an explanatory view showing the configuration of the pouring portion 710g of the seventh embodiment. As shown in FIG. 12, the pouring portion 710g of the seventh embodiment is different from the pouring portion 710d of the fourth embodiment in that the pouring portion 710g does not include the first groove portions 715a, the second groove portions 715b, and the third groove portions 715c.

According to the printer 100 of the above-described seventh embodiment, since the fourth groove portions 715d are provided, ink leaking from the ink bottle 200 can be restrained from adhering to and stagnating at the outer peripheral surface of the needle portion 711 and contamination of a hand of a user or each portion of the printer 100 that is caused by ink when ink adhering to the needle portion 711 adheres to the ink bottle 200 or trickles out of the pouring portion 710f can be suppressed. In addition, since the upper ends of the fourth groove portions 715d are positioned below the sealed portion 221 disposed at the ink outlet portion 210 of the ink bottle 200 in a state where the ink bottle 200 is coupled to the needle portion 711, the upper end portions of the fourth groove portions 715d being positioned above the sealed portion 221 in a state where the ink bottle 200 is coupled to the needle portion 711 can be avoided and thus ink leakage that occurs when airtightness achieved by the sealed portion 221 is lost due to the fourth groove portions 715d can be suppressed.

### H. Other Embodiments

H1. In the above-described embodiments, the inner bottom portion 713 is a flat surface that is not inclined. However, the present disclosure is not limited thereto. The inner bottom portion 713 may be formed to be inclined such that the height thereof decreases toward the communication portion 714. Note that the inner bottom portion 713 may be formed to be inclined in one direction toward the communication portion 714, or may be formed to be inclined around the communication portion 714 in a mortar-like shape. According to such an aspect, ink stagnating at the inner bottom portion 713 can be guided to the communication portion 714 by means of the inclination and thus ink can be further restrained from stagnating at the inner bottom portion 713.

H2. In the above-described embodiments, the bottom portions of the first groove portions 715a are flat surfaces that are not inclined. However, the present disclosure is not limited thereto. The bottom portions of the first groove portions 715a may be formed to be inclined such that the height thereof decreases toward the communication portions 714. According to such an aspect, ink held at the first groove portions 715a is more easily drawn to the communication portions 714. Therefore, ink can be prompted to be guided to the communication portions 714 and ink leaking from the ink bottle 200 can be further restrained from stagnating at the inner bottom portion 713.

H3. In the above-described embodiments, the communication portions 714 have cylindrical shapes. However, the present disclosure is not limited thereto. The communication portions 714 may have any shape such as a quadrangular tubular shape or an elliptical tubular shape. According to such an aspect as well, the same effects as those of the above-described embodiments are achieved.

H4. In the above-described embodiments, the communication portions 714 are provided between the needle portion 711 and the peripheral wall 712 at positions that do not abut both of the inner peripheral surface of the peripheral wall 712 and the outer peripheral surface of the needle portion 711. However, the present disclosure is not limited thereto. The communication portions 714 may be provided at positions that abut at least one of the inner peripheral surface of the peripheral wall 712 and the outer peripheral surface of the needle portion 711. According to such an aspect as well, the same effects as those of the above-described embodiments are achieved.

In an aspect in which the communication portions 714 are provided at positions that abut the inner peripheral surface of the peripheral wall 712, the third groove portions 715c of the pouring portion 710c in the third embodiment and the pouring portion 710f in the sixth embodiment may be provided to directly communicate with the communication portions 714. According to such an aspect, an effect in which ink held at the third groove portions 715c can be directly guided to the communication portions 714 and ink adhering to the inner peripheral surface of the peripheral wall 712 can be more efficiently guided to the communication portions 714 is further achieved. In addition, when the communication portions 714 are provided at positions that abut the inner peripheral surface of the peripheral wall 712, the pouring portions 710b to 710d may not include the second groove portions 715b.

In addition, in an aspect in which the communication portions 714 are provided at positions that abut the outer peripheral surface of the needle portion 711, the fourth groove portions 715d of the pouring portion 710d in the fourth embodiment and the pouring portion 710g in the seventh embodiment may be provided to directly communicate with the communication portions 714. According to such an aspect, an effect in which ink held at the fourth groove portions 715d can be directly guided to the communication portions 714 and ink adhering to the outer peripheral surface of the needle portion 711 can be more efficiently guided to the communication portions 714 is further achieved.

H5. In the above-described third embodiment, the third groove portions 715c are formed to be parallel to the height direction of the peripheral wall 712. However, the present disclosure is not limited thereto. The third groove portions 715c may be formed to be inclined with respect to the height direction of the peripheral wall 712. According to such an aspect as well, the same effects as those of the above-described embodiments are achieved. In addition, since the third groove portions 715c can be disposed at the inner peripheral surface of the peripheral wall 712 over a wider region in a circumferential direction, ink adhering to the inner peripheral surface of the peripheral wall 712 over a wider region can be easily held at the third groove portions 715c. Therefore, ink leaking from the ink bottle 200 can be restrained from adhering to and stagnating at the inner peripheral surface of the peripheral wall 712 and contamination that is caused when ink adhering to the peripheral wall 712 adheres to the ink bottle 200 and contamination of each portion of an outer side of the peripheral wall 712 that is caused by ink can be further suppressed.

In addition, each of the third groove portions 715c may include, in addition to a first groove formed to be parallel to the height direction of the peripheral wall 712, a second groove that extends from the first groove in a branch-like shape to be parallel to or inclined with respect to the circumferential direction of the inner peripheral surface of the peripheral wall 712. According to such an aspect as well, the third groove portion 715c can be disposed at the inner peripheral surface of the peripheral wall 712 over a wider region in the circumferential direction because of the second groove extending in a branch-like shape and thus ink trickling along the inner peripheral surface of the peripheral wall 712 can be easily held at the third groove portion 715c.

H6. In the above-described fourth embodiment, the fourth groove portions 715d are formed to be parallel to the height direction of the needle portion 711. However, the present disclosure is not limited thereto. The fourth groove portions 715d may be formed to be inclined with respect to the height direction of the needle portion 711. According to such an aspect as well, the same effects as those of the above-described embodiments are achieved. In addition, since the fourth groove portions 715d can be disposed at the outer peripheral surface of the needle portion 711 over a wider region in a circumferential direction, ink adhering to the outer peripheral surface of the needle portion 711 over a wider region can be easily held at the fourth groove portions 715d. Therefore, ink leaking from the ink bottle 200 can be restrained from adhering to and stagnating at the outer peripheral surface of the needle portion 711 and contamination that is caused when ink adhering to the needle portion 711 adheres to the ink bottle 200 and contamination of each portion of an outer side of the peripheral wall 712 that is caused by ink can be further suppressed.

In addition, each of the fourth groove portions 715d may include, in addition to a first groove formed to be parallel to the height direction of the needle portion 711, a second groove that extends from the first groove in a branch-like shape to be parallel to or inclined with respect to the circumferential direction of the outer peripheral surface of the needle portion 711. According to such an aspect as well, the fourth groove portion 715d can be disposed at the outer peripheral surface of the needle portion 711 over a wider region in the circumferential direction because of the second groove extending in a branch-like shape and thus ink trickling along the outer peripheral surface of the needle portion 711 can be easily held at the fourth groove portion 715d.

H7. In the above-described third embodiment, the third groove portions 715c are formed up to an upper end portion of the peripheral wall 712 and are open upward. However, the present disclosure is not limited thereto. Upper end portions of the third groove portions 715c may be formed at any positions in the height direction of the peripheral wall 712. According to such an aspect as well, the same effects as those of the above-described embodiments are achieved.

### I. Other Aspects

The present disclosure is not limited to the above-described embodiments, and can be realized in the form of various configurations within the scope not departing from the concept of the present disclosure. For example, technical features in the embodiments corresponding to technical features in each aspect to be described below can be replaced or combined as appropriate to solve some or all of the problems described above, or to achieve some or all of the effects described above. In addition, unless the technical features are described as essential in the present specification, deletion is possible as appropriate.

1. According to a first aspect of the present disclosure, there is provided an ink jet recording apparatus including a recording head that records an image by ejecting ink and an ink tank including an ink accommodation chamber that accommodates the ink to be supplied to the recording head and a pouring portion that communicates with the ink accommodation chamber and through which the ink is poured from an ink bottle. In the ink jet recording apparatus, the pouring portion includes a needle portion that communicates with the ink accommodation chamber, a peripheral wall that is disposed to surround an outer periphery of the needle portion, an inner bottom portion that receives the ink inside the peripheral wall, one or more communication portions that are open at the inner bottom portion and that communicate with the ink accommodation chamber, and a plurality of groove portions of which at least a portion is formed at the inner bottom portion, and the plurality of groove portions are configured to communicate with at least one of the one or more communication portions such that two or more groove portions communicate with each communication portion. According to the aspect, since at least a portion of the plurality of groove portions is configured such that two or more groove portions communicate with one communication portion, ink can be prompted to be guided to the communication portion in comparison with an aspect in which only one groove portion communicates with one communication portion. Therefore, ink leaking from the ink bottle can be further restrained from stagnating at the inner bottom portion and contamination of a hand of a user or each portion of the ink jet recording apparatus that is caused by ink when ink stagnating at the inner bottom portion adheres to the ink bottle or trickles out of the pouring portion can be suppressed.

2. In the above-described aspect, at least a portion of the plurality of groove portions may be configured to become thinner toward the communication portion. According to the aspect, the magnitude and the probability of capillary action in the groove portions can be increased toward the communication portion and thus ink held at the groove portions is easily drawn into the communication portion. Therefore, ink can be prompted to be guided to the communication portions and ink leaking from the ink bottle can be further restrained from stagnating at the inner bottom portion.

3. In the above-described aspect, the plurality of groove portions may include a first groove portion that is formed at the inner bottom portion and that guides the ink to the communication portion from a base of the needle portion, and a second groove portion that is formed at the inner bottom portion and that guides the ink to the communication portion from the peripheral wall. According to the aspect, ink trickling along the needle portion can be restrained from stagnating at the inner bottom portion since the plurality of groove portions include the first groove portion. In addition, since the plurality of groove portions include the second groove portion, ink that leaks from the ink bottle, that adheres to the peripheral wall, and that trickles along the peripheral wall can be restrained from stagnating at the inner bottom portion. Therefore, ink leaking from the ink bottle can be further restrained from stagnating at the inner bottom portion and contamination of a hand of a user or each portion of the ink jet recording apparatus that is caused by ink when ink adhering to the peripheral wall adheres to the ink bottle or trickles out of the pouring portion can be further suppressed.

4. In the above-described aspect, the plurality of groove portions may further include third groove portions that are formed at an inner peripheral surface of the peripheral wall and that guide the ink toward the inner bottom portion. According to the aspect, since the plurality of groove portions include the third groove portions, ink leaking from the ink bottle can be restrained from adhering to and stagnating at the inner peripheral surface of the peripheral wall and contamination of a hand of a user or each portion of the ink jet recording apparatus that is caused by ink when ink adhering to the peripheral wall adheres to the ink bottle or trickles out of the pouring portion can be suppressed.

5. In the above-described aspect, the plurality of groove portions may further include a second groove portion that is formed at the inner bottom portion and that guides the ink to the communication portion from the peripheral wall and at least a portion of the third groove portions may communicate with the second groove portion. According to the aspect, ink held at the third groove portions can be directly guided to the second groove portion and ink adhering to the inner peripheral surface of the peripheral wall can be more efficiently guided to the communication portion. Therefore, ink leaking from the ink bottle can be restrained from adhering to and stagnating at the inner peripheral surface of the peripheral wall and contamination of a hand of a user or each portion of the ink jet recording apparatus that is caused by ink when ink adhering to the peripheral wall adheres to the ink bottle or trickles out of the pouring portion can be further suppressed.

6. In the above-described aspect, the plurality of groove portions may include a fourth groove portion that is formed at an outer peripheral surface of the needle portion and that guides the ink toward the inner bottom portion and an upper end of the fourth groove portion may be positioned below a sealed portion disposed at an ink outlet portion of the ink bottle in a state where the ink bottle is coupled to the needle portion. According to the aspect, since the plurality of groove portions include the fourth groove portion, ink leaking from the ink bottle can be restrained from adhering to and stagnating at the outer peripheral surface of the needle portion and contamination of a hand of a user or each portion of the ink jet recording apparatus that is caused by ink when ink adhering to the needle portion adheres to the ink bottle or trickles out of the pouring portion can be suppressed. In addition, since the upper end of the fourth groove portion is positioned below the sealed portion disposed at the ink outlet portion of the ink bottle in a state where the ink bottle is coupled to the needle portion, the upper end portion of the fourth groove portion being positioned above the sealed portion in a state where the ink bottle is coupled to the needle portion can be avoided and thus ink leakage that occurs when airtightness achieved by the sealed portion is lost due to the fourth groove portion can be suppressed.

7. According to a second aspect of the present disclosure, there is provided an ink jet recording apparatus including a recording head that records an image by ejecting ink and an ink tank including an ink accommodation chamber that accommodates the ink to be supplied to the recording head and a pouring portion that communicates with the ink accommodation chamber and through which the ink is poured from an ink bottle. In the ink jet recording apparatus, the pouring portion includes a needle portion that communicates with the ink accommodation chamber, a peripheral wall that is disposed to surround an outer periphery of the needle portion, an inner bottom portion that receives the ink inside the peripheral wall, and one or more communication portions that are open at the inner bottom portion and that communicate with the ink accommodation chamber, and the peripheral wall includes a third groove portion that is formed at an inner peripheral surface of the peripheral wall and that guides the ink toward the inner bottom portion. According to the aspect, since the third groove portion is formed at the inner peripheral surface of the peripheral wall, ink leaking from the ink bottle can be restrained from adhering to and stagnating at the inner peripheral surface of the peripheral wall and contamination of a hand of a user or each portion of the ink jet recording apparatus that is caused by ink when ink adhering to the peripheral wall adheres to the ink bottle or trickles out of the pouring portion can be suppressed.

8. In the above-described aspect, the inner bottom portion may include a second groove portion that communicates with the third groove portion and that guides the ink toward the communication portion from the peripheral wall. According to the aspect, ink held at the third groove portion can be directly guided to the second groove portion and ink adhering to the inner peripheral surface of the peripheral wall can be more efficiently guided to the communication portion. Therefore, ink leaking from the ink bottle can be restrained from adhering to and stagnating at the inner peripheral surface of the peripheral wall and contamination of a hand of a user or each portion of the ink jet recording apparatus that is caused by ink when ink adhering to the peripheral wall adheres to the ink bottle or trickles out of the pouring portion can be further suppressed.

9. According to a third aspect of the present disclosure, there is provided an ink jet recording apparatus including a recording head that records an image by ejecting ink and an ink tank including an ink accommodation chamber that accommodates the ink to be supplied to the recording head and a pouring portion that communicates with the ink accommodation chamber and through which the ink is poured from an ink bottle. In the ink jet recording apparatus, the pouring portion includes a needle portion that communicates with the ink accommodation chamber, a peripheral wall that is disposed to surround an outer periphery of the needle portion, an inner bottom portion that receives the ink inside the peripheral wall, and one or more communication portions that are open at the inner bottom portion and that communicate with the ink accommodation chamber, the needle portion includes a fourth groove portion that is formed at an outer peripheral surface of the needle portion and that guides the ink toward the inner bottom portion, and an upper end of the fourth groove portion is positioned below a sealed portion disposed at an ink outlet portion of the ink bottle in a state where the ink bottle is coupled to the needle portion. According to the aspect, since the fourth groove portion is formed at the outer peripheral surface of the needle portion, ink leaking from the ink bottle can be restrained from adhering to and stagnating at the outer peripheral surface of the needle portion and contamination of a hand of a user or each portion of the ink jet recording apparatus that is caused by ink when ink adhering to the needle portion adheres to the ink bottle or trickles out of the pouring portion can be suppressed. In addition, since the upper end of the fourth groove portion is positioned below the sealed portion disposed at the ink outlet portion of the ink bottle in a state where the ink bottle is coupled to the needle portion, the upper end portion of the fourth groove portion being positioned above the sealed portion in a state where the ink bottle is coupled to the needle portion can be avoided and thus ink leakage that occurs when airtightness achieved by the sealed portion is lost due to the fourth groove portion can be suppressed.

10. In the above-described aspect, the inner bottom portion may include a first groove portion that communicates with the fourth groove portion and that guides the ink to the communication portion. According to the aspect, ink held at the fourth groove portion can be directly guided to the first groove portion and ink adhering to the outer peripheral surface of the needle portion can be more efficiently guided to the communication portion. Therefore, ink leaking from the ink bottle can be restrained from adhering to and stagnating at the outer peripheral surface of the needle portion and contamination of a hand of a user or each portion of the ink jet recording apparatus that is caused by ink when ink adhering to the needle portion adheres to the ink bottle or trickles out of the pouring portion can be further suppressed.

11. In the above-described aspect, the communication portion may include a fifth groove portion that is formed at an inner peripheral surface of the communication portion and that guides the ink toward the ink accommodation chamber. Therefore, ink stagnating at the inner bottom portion is guided to the ink accommodation chamber through the fifth groove portion and the ink stagnating at the inner bottom portion can be prompted to be guided to the ink accommodation chamber. Therefore, ink leaking from the ink bottle can be further restrained from stagnating at the inner bottom portion and contamination of a hand of a user or each portion of the ink jet recording apparatus that is caused by ink when ink stagnating at the inner bottom portion adheres to the ink bottle or trickles out of the pouring portion can be further suppressed.

The present disclosure can be realized in aspects such as a method of manufacturing an ink jet recording apparatus in addition to the aspects described above.

What is claimed is:

1. An ink jet recording apparatus comprising:
a recording head that records an image by ejecting ink; and
an ink tank including an ink accommodation chamber that accommodates the ink to be supplied to the recording head and a pouring portion that communicates with the ink accommodation chamber and through which the ink is poured from an ink bottle, wherein
the pouring portion includes
a needle portion that communicates with the ink accommodation chamber,
a peripheral wall that is disposed to surround an outer periphery of the needle portion,
an inner bottom portion that receives the ink inside the peripheral wall,
one or more communication portions that are open at the inner bottom portion and that communicate with the ink accommodation chamber, and
a plurality of groove portions of which at least a portion is formed at the inner bottom portion, and
the plurality of groove portions are configured to communicate with at least one of the one or more communication portions such that two or more groove portions communicate with each communication portion.

2. The ink jet recording apparatus according to claim 1, wherein
at least a portion of the plurality of groove portions is configured to become thinner toward the communication portion.

3. The ink jet recording apparatus according to claim 1, wherein
the plurality of groove portions include
a first groove portion that is formed at the inner bottom portion and that guides the ink to the communication portion from a base of the needle portion, and
a second groove portion that is formed at the inner bottom portion and that guides the ink to the communication portion from the peripheral wall.

4. The ink jet recording apparatus according to claim 1, wherein
the plurality of groove portions further include third groove portions that are formed at an inner peripheral surface of the peripheral wall and that guide the ink toward the inner bottom portion.

5. The ink jet recording apparatus according to claim 4, wherein
the plurality of groove portions further include a second groove portion that is formed at the inner bottom portion and that guides the ink to the communication portion from the peripheral wall, and
at least a portion of the third groove portions communicates with the second groove portion.

6. The ink jet recording apparatus according to claim 1, wherein
the plurality of groove portions include a fourth groove portion that is formed at an outer peripheral surface of the needle portion and that guides the ink toward the inner bottom portion, and
an upper end of the fourth groove portion is positioned below a sealed portion disposed at an ink outlet portion of the ink bottle in a state where the ink bottle is coupled to the needle portion.

7. An ink jet recording apparatus comprising:
a recording head that records an image by ejecting ink; and
an ink tank including an ink accommodation chamber that accommodates the ink to be supplied to the recording head and a pouring portion that communicates with the ink accommodation chamber and through which the ink is poured from an ink bottle, wherein
the pouring portion includes
a needle portion that communicates with the ink accommodation chamber,
a peripheral wall that is disposed to surround an outer periphery of the needle portion,
an inner bottom portion that receives the ink inside the peripheral wall, and
one or more communication portions that are open at the inner bottom portion and that communicate with the ink accommodation chamber, and
the peripheral wall includes a third groove portion that is formed at an inner peripheral surface of the peripheral wall and that guides the ink toward the inner bottom portion.

8. The ink jet recording apparatus according to claim 7, wherein
the inner bottom portion includes a second groove portion that communicates with the third groove portion and that guides the ink toward the communication portion from the peripheral wall.

9. An ink jet recording apparatus comprising:
a recording head that records an image by ejecting ink; and
an ink tank including an ink accommodation chamber that accommodates the ink to be supplied to the recording head and a pouring portion that communicates with the ink accommodation chamber and through which the ink is poured from an ink bottle, wherein
the pouring portion includes
a needle portion that communicates with the ink accommodation chamber,
a peripheral wall that is disposed to surround an outer periphery of the needle portion,
an inner bottom portion that receives the ink inside the peripheral wall, and
one or more communication portions that are open at the inner bottom portion and that communicate with the ink accommodation chamber,
the needle portion includes a fourth groove portion that is formed at an outer peripheral surface of the needle portion and that guides the ink toward the inner bottom portion, and
an upper end of the fourth groove portion is positioned below a sealed portion disposed at an ink outlet portion of the ink bottle in a state where the ink bottle is coupled to the needle portion.

10. The ink jet recording apparatus according to claim 9, wherein
the inner bottom portion includes a first groove portion that communicates with the fourth groove portion and that guides the ink to the communication portion.

11. The ink jet recording apparatus according to claim 1, wherein
the communication portion includes a fifth groove portion that is formed at an inner peripheral surface of the communication portion and that guides the ink toward the ink accommodation chamber.
